(19) United States
(12) Patent Application Publication
(10) Pub. No.: US 2025/0066630 A1
(43) Pub. Date: Feb. 27, 2025

(54) AQUEOUS INKJET INKS CONTAINING A POLYURETHANE POLYMER

(71) Applicant: DUPONT ELECTRONICS, INC., Wilmington, DE (US)

(72) Inventors: Xiaoqing Li, NEWARK, DE (US); Ji Yeon Huh, NEWARK, DE (US)

(21) Appl. No.: 18/710,268

(22) PCT Filed: Oct. 28, 2022
(86) PCT No.: PCT/US2022/078849

§ 371 Date: May 15, 2024

Related U.S. Application Data
(60) Provisional application No. 63/289,346, filed on Dec. 14, 2021.

(51) Int. Cl. C09D 11/322; C09D 175/04

(52) U.S. Cl. CPC C09D 11/322; C09D 175/04

(57) ABSTRACT

The present disclosure pertains to an aqueous inkjet ink containing a pigment as colorant, a polymeric dispersant, a polyurethane binder, and an aqueous vehicle. The inks show improved properties for printing on low and non-absorption substrates.

### CROSS REFERENCE TO RELATED APPLICATIONS

This application claims priority under 35 U.S.C. § 119 from U.S. Provisional Application Ser. No. 63/289,346, filed Dec. 14, 2021.

### BACKGROUND OF THE DISCLOSURE

The present disclosure pertains to an aqueous ink containing an aqueous vehicle, a pigment, a polymeric dispersant to disperse the pigment, and a polyurethane polymer as a binder. The aqueous vehicle contains organic solvents with boiling points not higher than 230° C. at ambient atmospheric pressure.

Inkjet printing is a non-impact digital printing process in which droplets of ink are deposited on a substrate, such as paper, to form the desired image. Inkjet printers are equipped with an ink set which, for full color printing, typically comprises a cyan ink, a magenta ink, a yellow ink, and an additional black ink (CMYK) with the black ink being the most common ink. For transparent substrate such as clear plastics, a white ink is commonly needed for enhancing color images. In this case, an ink set typically comprises CMYKW inks.

Inkjet printing is becoming increasingly important for markets other than conventional desktop printing for small office/home office. Digital printing methods have gained popularity in commercial and packaging printing and offer several benefits over conventional printing methods such as screen printing, offset printing, flexo and gravure printing. Inkjet digital printing eliminates the setup expense associated with screen and plate preparation, and can potentially enable cost effective short run production. Expansion of inkjet in these new applications has brought the needs for direct printing to low absorption substrate such as coated papers, coated corrugated board and folding carton, and non-absorption plastic substrate such as vinyl, polystyrene and polypropylene boards, and flexible polypropylene, polyester, nylon and polyethylene films. Compared with plain paper and special inkjet paper, an ink's little or no penetration on low and non-absorption substrates leads to slow drying, poor image quality, and prints sticking together before use. These defects worsen especially when printing at high speed. In order to address these problems, inks can be formulated with low-boiling point water-soluble organic solvents to improve the volatility of the aqueous ink and drying rate. However, aqueous ink having faster volatility tends to run into jettability issue, which is especially problematic when an ink is being ejected after the printhead is left idle or uncapped for long periods of time, and nozzles of the printhead are partially clogged as a result of an ink's fast drying and solidification. Moreover, inks for commercial and packaging printing applications on low and non-absorption substrates are typically formulated with polymeric binders to reduce solvent loading to achieve even faster drying rate and durability requirements such as smudge and smear resistance. Polymer binder containing ink further degrades the jetting reliability with ink more prone to forming films and plugging around the nozzle. On the other hand, if the solidified ink comprising mainly pigment and polymer can be easily redissolved or redispersed by the bulk ink, a plugged nozzle may be recovered with a process of ink priming or flushing, enabling reliable jetting.

U.S. Pat. No. 8,636,839 discloses an ink jet ink that can achieve high scratch resistance and highlighter resistance of images and excellent ink ejection stability. The ink contains a polyurethane polymer with acid number in the range of 20 mgKOH/g to 100 mgKOH/g, and contain units derived from a polyisocyanate, a polyol, a compound having a carboxy group, and a compound having a sulfo group. This reference does not teach the combination of its polyurethane polymer with certain water-soluble organic solvents.

A need exists for inkjet inks that are capable of providing faster drying and image durability on low and non-absorption substrate while possessing good redispersibility attributes for reliable jetting performances. The present disclosure satisfies this need by providing ink compositions having a combination of particular polyurethane binders and solvents with boiling points not higher than 230° C. at ambient atmospheric pressure.

### SUMMARY OF THE DISCLOSURE

An embodiment provides an aqueous inkjet ink comprising an aqueous vehicle, a pigment, and a polyurethane binder; wherein the pigment is stabilized by a polymeric dispersant selected from the group consisting of polyurethane polymer, acrylic polymer, hydrolyzed styrene maleic anhydride copolymer, and mixtures thereof; the polyurethane binder comprising units derived from a diisocyanate, a first polydiol with OH number from 28 to 800, a second polydiol with a tertiary amine neutralized carboxyl group, a third polydiol or a diamine with an alkaline neutralized sulfonic acid group, and at least one triol and/or one polyamine, or mixtures thereof; and wherein the aqueous vehicle comprising one or more water soluble organic solvents with boiling points lower than 230° C. at ambient atmospheric pressure.

Another embodiment provides that the polymeric dispersant is polyurethane polymer.

Another embodiment provides that the polyurethane binder contains units derived from a diisocyanate, a first polydiol with OH number from 28 to 800, a second polydiol with a tertiary amine neutralized COOH group, a third polydiol with an alkaline neutralized sulfonic acid group, and at least one triol.

Another embodiment provides that the polyurethane binder contains units derived from a diisocyanate, a first polydiol with OH number from 28 to 800, a second polydiol with a tertiary amine neutralized COOH group, a third polydiol with an alkaline neutralized sulfonic acid group, and at least one polyamine.

Another embodiment provides that the the polyurethane binder contains units derived from a diisocyanate, a first polydiol with OH number from 28 to 800, a second polydiol with a tertiary amine neutralized COOH group, a diamine with an alkaline neutralized sulfonic acid group, and at least one triol and one polyamine.

Another embodiment provides that the polymeric dispersant is acrylic polymer.

Yet another embodiment provides that the polymeric dispersant is hydrolyzed styrene maleic anhydride (SMA) copolymer.

These and other features and advantages of the present embodiments will be more readily understood by those of ordinary skill in the art from a reading of the following detailed description. Certain features of the disclosed embodiments which are, for clarity, described above and below as separate embodiments, may also be provided in combination in a single embodiment. Conversely, various features of the disclosed embodiments that are described in the context of a single embodiment, may also be provided separately or in any subcombination.

### DETAILED DESCRIPTION

Unless otherwise stated or defined, all technical and scientific terms used herein have commonly understood meanings by one of ordinary skill in the art to which this disclosure pertains.

Unless stated otherwise, all percentages, parts, ratios, etc., are by weight.

When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range.

When the term “about” is used in describing a value or an end-point of a range, the disclosure should be understood to include the specific value or end-point referred to.

As used herein, the term “dispersion” means a two-phase system wherein one phase consists of finely divided particles (often in a colloidal size range) distributed throughout a bulk substance, the particles being the dispersed or internal phase and the bulk substance being the continuous or external phase.

As used herein, the term “dispersant” means a surface active agent added to a suspending medium to promote uniform and maximum separation of extremely fine solid particles often of colloidal sizes. For pigments, the dispersants are most often polymeric dispersants, and the dispersants and pigments are usually combined using a dispersing equipment.

As used herein, the term “aqueous vehicle” refers to water or a mixture of water and at least one water-soluble, or partially water-soluble (i.e., methyl ethyl ketone), organic solvent (co-solvent).

As used herein, the term “substantially” means being of considerable degree, al-most all.

As used herein, the term “dyne/cm” means dyne per centimetre, a surface tension unit.

As used herein, the term “cP” means centipoise, a viscosity unit.

The materials, methods, and examples herein are illustrative only except as explicitly stated, and are not intended to be limiting.

In addition, references in the singular may also include the plural (for example, “a” and “an” may refer to one, or one or more) unless the context specifically states otherwise.

### Ink Sets

The term “ink set” refers to all the individual inks or other fluids an inkjet printer is equipped to jet. The white inks used to print the image after printing the colored inks or the white ink used to print prior to printing the colored inks are considered part of the ink set.

In one preferred embodiment, the ink set comprises at least two differently colored inkjet inks, at least one of which is a white pigmented inkjet ink as described above.

In another preferred embodiment, the ink set comprises at least four differently colored inkjet inks, wherein at least one is a cyan inkjet ink, at least one is a magenta inkjet ink, at least one is a yellow inkjet ink, and at least one is a white inkjet ink.

In addition to the colored inkjet inks just mentioned, it is also preferable to include a black inkjet ink in the ink set.

In addition to the CMYKW inks mentioned above, the ink sets may contain additional differently colored inks, as well as different strength versions of the CMYKW and other inks.

For example, the ink sets of the present invention can comprise full-strength versions of one or more of the inks in the ink set, as well as “light” versions thereof.

Additional colors for the inkjet ink set include, for example, orange, violet, green, red and/or blue.

The preferred ink sets inks are pigmented inks.

### Pigments

The colorant used for printing the colored image may be a dye or a pigment. Dyes include disperse dyes, reactive dyes, acid dyes and the like. The term “pigment” as used herein means an insoluble colorant that requires to be dispersed with a dispersant and processed under dispersive conditions in the presence of a dispersant. Pigmented inks are preferred.

Pigments suitable for being used are those generally well-known in the art for aqueous inkjet inks. The selected pigment(s) may be used in dry or wet form. For example, pigments are usually manufactured in aqueous media, and the resulting pigments are obtained as a water-wet presscake. In presscake form, the pigment does not agglomerate to the extent it would in dry form. Thus, pigments in water-wet presscake form do not require as much mixing energy to de-agglomerate in the premix process as pigments in dry form. Representative commercial dry pigments are listed in U.S. Pat. No. 5,085,698.

Some examples of pigments with coloristic properties useful in inkjet inks include, but not limited to: cyan pigments from Pigment Blue 15:3 and Pigment Blue 15:4; magenta pigments from Pigment Red 122 and Pigment Red 202; yellow pigments from Pigment Yellow 14, Pigment Yellow 74, Pigment Yellow 95, Pigment Yellow 110, Pigment Yellow 114, Pigment Yellow 128 and Pigment Yellow 155; red pigments from Pigment Orange 5, Pigment Orange 34, Pigment Orange 43, Pigment Orange 62, Pigment Red 17, Pigment Red 49:2, Pigment Red 112, Pigment Red 149, Pigment Red 177, Pigment Red 178, Pigment Red 188, Pigment Red 254, Pigment Red 184, Pigment Red 264 and Pigment Red PV19; green pigments from Pigment Green 1, Pigment Green 2, Pigment Green 7 and Pigment Green 36; blue pigments from Pigment Blue 60, Pigment Violet 3, Pigment Violet 19, Pigment Violet 23, Pigment Violet 32, Pigment Violet 36 and Pigment Violet 38; and black pigment carbon black. The pigment names and abbreviations used herein are the “C.I.” designation for pigments established by Society of Dyers and Colourists, Bradford, Yorkshire, UK and published in The Color Index, Third Edition, 1971.

Examples of white color materials include, but are not limited to, white inorganic pigments such as Titanium Oxide, Zinc Oxide, zinc sulfide, antimony oxide, and zirconium oxide. Besides such white inorganic pigments, white organic pigments such as white hollow resin particles and polymeric particles can also be used. The preferred pigment for the aqueous pigmented white ink is titanium dioxide. Titanium dioxide (TiO2) pigment useful may be in the rutile or anatase crystalline form. It is commonly made by either a chloride process or a sulfate process. In the chloride process, TiCl4 is oxidized to TiO2 particles. In the sulfate process, sulfuric acid and ore containing titanium are dissolved, and the resulting solution goes through a series of steps to yield TiO2. Both the sulfate and chloride processes are described in greater detail in “The Pigment Handbook”, Vol. 1, 2nd Ed., John Wiley & Sons, NY (1988), the relevant disclosure of which is incorporated by reference herein for all purposes as if fully set forth.

The titanium dioxide particles can have a wide variety of average particle sizes of about 1 micron or less, depending on the desired end use application of the ink. For applications demanding high hiding or decorative printing applications, the titanium dioxide particles preferably have an average size of less than about 1 micron (1000 nanometers). Preferably, the particles have an average size of from about 50 to about 950 nanometers, more preferably from about 75 to about 750 nanometers, and still more preferably from about 100 to about 500 nanometers. These titanium dioxide particles are commonly called pigmentary TiO2.

For applications demanding white color with some degree of transparency, the pigment preference is “nano” titanium dioxide. “Nano” titanium dioxide particles typically have an average size ranging from about 10 to about 200 nanometers, preferably from about 20 to about 150 nanometers, and more preferably from about 35 to about 75 nanometers. An ink comprising nano titanium dioxide can provide improved chroma and transparency, while still retaining good resistance to light fade and appropriate hue angle. A commercially available example of an uncoated nano grade of titanium oxide is P-25, available from Degussa (Parsippany N.J.).

The titanium dioxide pigment may be substantially pure titanium dioxide or may contain other metal oxides, such as silica, alumina and zirconia. Other metal oxides may become incorporated into the pigment particles, for example, by co-oxidizing or co-precipitating titanium compounds with other metal compounds. If co-oxidized or co-precipitated metals are present, they are preferably present as the metal oxide in an amount from about 0.1 wt % to about 20 wt %, more preferably from about 0.5 wt % to about 5 wt %, and still more preferably from about 0.5 wt % to about 1.5 wt %, based on the total titanium dioxide pigment weight.

The titanium dioxide pigment may also bear one or more metal oxide surface coatings. These coatings may be applied using techniques known by those skilled in the art. Examples of metal oxide coatings include silica, alumina, alumina-silica, boria and zirconia, among others. Such coatings may optionally be present in an amount of from about 0.1 wt % to about 10 wt %, and preferably from about 0.5 wt % to about 3 wt %, based on the total weight of the titanium dioxide pigment. These coatings can provide improved properties including reducing the photoreactivity of the titanium dioxide. Commercial examples of such coated titanium dioxides include R700 (alumina-coated, available from Chemours, Wilmington Del.), RDI-S (alumina-coated, available from Kemira Industrial Chemicals, Helsinki, Finland), R706 (available from Chemours, Wilmington Del.) and W-6042 (a silica alumina treated nano grade titanium dioxide from Tayco Corporation, Osaka Japan).

The titanium dioxide pigment may also bear one or more organic surface coatings, such as, for example, carboxylic acids, silanes, siloxanes and hydrocarbon waxes, and their reaction products with the titanium dioxide surface. The amount of organic surface coating, when present, generally ranges from about 0.01 wt % to about 6 wt %, preferably from about 0.1 wt % to about 3 wt %, more preferably about 0.5 wt % to about 1.5 wt %, and still more preferably about 1 wt %, based on the total weight of the pigment.

### Polymeric Dispersant

Traditionally, pigments are stabilized by dispersing agents, such as polymeric dispersants or surfactants, to produce a stable dispersion of the pigment in the vehicle. More recently though, so-called “self-dispersible” or “self-dispersing” pigments (hereafter “SDP”) have been developed. As the name would imply, SDPs are dispersible in water without dispersants.

The polymeric dispersant for the non-self-dispersing pigment(s) may be a random or a structured polymer. Typically, the acrylic based polymer dispersant is a copolymer of hydrophobic and hydrophilic monomers. Some examples of hydrophobic monomers used are methyl methacrylate, n-butyl methacrylate, 2-ethylhexyl methacrylate, benzyl methacrylate, 2-phenylethyl methacrylate and the corresponding acrylates. Examples of hydrophilic monomers are methacrylic acid, acrylic acid, dimethylaminoethyl(meth)acrylate and salts thereof. Quaternary salts of dimethylaminoethyl(meth)acrylate may also be employed. The “random polymer” means polymers where molecules of each monomer are randomly arranged in the polymer backbone. For a reference on suitable random polymeric dispersants, see: U.S. Pat. No. 4,597,794. The “structured polymer” means polymers having a block, branched, graft or star structure. Examples of structured polymers include AB or BAB block copolymers such as the ones disclosed in U.S. Pat. No. 5,085,698; ABC block copolymers such as the ones disclosed in EP Patent Specification No. 0556649; and graft polymers such as the ones disclosed in U.S. Pat. No. 5,231,131. Other polymeric dispersants that can be used are described, for example, in U.S. Pat. Nos. 6,117,921, 6,262,152, 6,306,994 and 6,433,117.

The “random polymer” also includes polyurethanes. Particularly useful are the polyurethane dispersant disclosed in U.S. Patent Application Publication No. 2012/0214939 where the polyurethane dispersant is crosslinked after dispersing a pigment to form a pigment dispersion, the relevant disclosure of which is incorporated by reference herein for all purposes as if fully set forth.

Another suitable type of polymeric dispersant is Styrene Maleic Anhydride (SMA) copolymer. A “Styrene Maleic Anhydride copolymer” or “SMA copolymer” is a polymer formed of styrene and maleic anhydride monomers, and optionally one or more further comonomers. The copolymers can have a molar ratio of the styrene/maleic anhydride repeating units from 0.2 to 5, preferably from 0.5 to 2. The dispersing agent is generally in the form of a hydrolyzed solution of SMA copolymer. The hydrolyzed solution preferably comprises the SMA copolymer dissolved in an aqueous alkaline solution. An aqueous alkaline solution is useful to hydrolyze the SMA copolymer because the copolymer is not readily soluble in water. The hydroxyl ions of the alkaline solution hydrolyze, or react with, a carbonyl carbon on the anhydride's ring cleaving a carbon-oxygen single bond. The reaction opens the anhydride ring, resulting in the formation of a mono-acid group. The aqueous alkaline solution used to dissolve the SMA copolymer is preferably prepared from ammonium hydroxide, sodium hydroxide, potassium hydroxide or an organic amine. Suitable hydrolyzed SMA copolymer solutions for the present invention include those commercially available from Polyscope Polymers under the trade names XIRAN® SL.

### Colored Pigment Dispersion

The color pigment dispersion which are stabilized by added polymer dispersant may be prepared by methods known in the art. It is generally desirable to make the stabilized pigment in a concentrated form. The stabilized pigment is first prepared by premixing the selected pigment(s) and polymeric dispersant(s) in an aqueous carrier medium (such as water and, optionally, a water-miscible solvent), and then dispersing or deflocculating the pigment. The premixing step is generally done in a stirred mixing vessel, and a high-speed disperser (HSD) is particularly suitable for the mixing step. A Cowels type blade attached to the HSD and operated at from 500 rpm to 4000 rpm, and more typically from 2000 rpm to 3500 rpm, provides optimal shear to achieve the desired mixing. Adequate mixing is usually achieved after mixing under the conditions described above for a period of from 15 to 120 minutes. The subsequent dispersing step may be accomplished in a 2-roll mill, media mill, a horizontal mini mill, a ball mill, an attritor, or by passing the mixture through a plurality of nozzles within a liquid jet interaction chamber at a liquid pressure of at least 5,000 psi to produce a uniform dispersion of the pigment particles in the aqueous carrier medium (microfluidizer). Alternatively, the concentrates may be prepared by dry milling the polymeric dispersant and the pigment under pressure. The media for the media mill is chosen from commonly available media, including zirconia, YTZ and nylon. These various dispersion processes are in a general sense well known in the art, as exemplified by U.S. Pat. Nos. 5,022,592, 5,026,427, 5,310,778, 5,891,231, 5,976,232 and US20030089277. The disclosures of each of these publications are incorporated by reference herein for all purposes as if fully set forth. Preferred are 2-roll mill, media mill, and by passing the mixture through a plurality of nozzles within a liquid jet interaction chamber at a liquid pressure of at least 5,000 psi.

After the milling process is complete the color pigment concentrate may be “let down” into an aqueous system. “Let down” refers to the dilution of the concentrate with mixing or dispersing, the intensity of the mixing/dispersing normally being determined by trial and error using routine methodology, and often being dependent on the combination of the polymeric dispersant, solvent and pigment.

The range of useful particle size after dispersion is typically from about 0.005 micrometers to about 15 micrometers. Typically, the pigment particle size should range from about 0.005 micrometers to about 5 micrometers; and, specifically, from about 0.005 micrometers to about 1 micrometer. The average particle size as measured by dynamic light scattering is less than about 500 nm, typically less than about 300 nm.

### White Pigment Dispersion

One or more dispersants described for colored pigment are also employed to stabilize the titanium dioxide. It is generally desirable to make the stabilized TiO2 pigment in concentrated slurry form. TiO2 slurry is generally done in a stirred mixing vessel, and a high-speed disperser (HSD) is particularly suitable for the mixing step. A Cowels type blade attached to the HSD and operated at from 500 rpm to 4000 rpm, and more typically from 2000 rpm to 3500 rpm, provides optimal shear to achieve the desired mixing. Adequate mixing is usually achieved after mixing under the conditions described above for a period of from 15 to 600 minutes. The amount of titanium dioxide present in the slurry composition is preferably from about 35 wt % to about 80 wt %, based on the total slurry weight, more preferably from about 50 wt % to about 75 wt %, based on the total weight of the slurry. The titanium dioxide has a 50% average particle size (hereinafter referred to as “D50”) that is preferably in the range of 50 to 500 nm, more preferably in the range of 150 to 350 nm. The titanium dioxide having a D50 within these ranges enables printed film to exhibit satisfactory opacity of the image, which enables formation of an image with high quality.

In the case of color pigments, the ink may contain up to approximately 30%, preferably about 0.1 to about 25%, and more preferably about 0.25 to about 10%, pigment by weight based on the total ink weight. If an inorganic pigment such as TiO2 pigment is selected, the ink will tend to contain higher weight percentages of pigment than with comparable inks employing color pigment, and may be as high as about 75% in some cases, since inorganic pigments generally have higher specific gravities than organic pigments.

Post Modification of a Polymeric Dispersant after Formation of a Pigment Dispersion

The polymeric dispersant dispersing a pigment may be crosslinked after a pigment dispersion is prepared to form a crosslinked pigment dispersion prior to its inclusion in an inkjet ink. The crosslinkable polymeric dispersant are polymers substituted with crosslinkable moieties selected from the group consisting of acetoacetoxy, acid, amine, epoxy, hydroxyl, blocked isocyanates and mixtures thereof. The crosslinking agent is selected from a group consisting of acetoacetoxy, acid, amine, anhydride, epoxy, hydroxyl, isocyanates, blocked isocyanates and mixtures thereof. In the crosslinking step, a crosslinking agent is added to the pigment dispersion after the pigment is dispersed and crosslinking took place by heating the mixture for several hours at elevated temperature. After the crosslinking step excess polymer can be removed by purification processes such as ultrafiltration. Specific examples of crosslinking moiety/agent pairs are hydroxyl/isocyanate and acid/epoxy.

### Ink Binder

A binder is a polymeric compound or a mixture of polymeric compounds that is added to the ink formulation. The binder can impart properties to the final printed material that, for example, gives greater durability to the printed material. Typical polymers used as binders in ink-jet inks include polyurethane dispersions and polyurethane solutions, polymers of acrylics, styrene acrylics, styrene butadienes, styrene butadiene acrylonitriles, neoprenes, ethylene acrylic acids, ethylene vinyl acetate emulsions, latexes and the like. The binder may be a solution or stabilized as an emulsion by having ionic substituents such as carboxylic acids, sulfur containing acids, amine groups, and other similar ionic groups. Typically, a binder is different from the polymer dispersant described above and is non-reactive to the colorant. The binder is typically added to an ink during the final formulation stage, not during the preparation of a pigment dispersion.

In the present disclosure, the ink binder is an aqueous polyurethane dispersion, more specifically a branched polyurethane colloidal particle stabilized with carboxyl and sulfonic acid functional groups in both acid and neutralized ionic form in aqueous solution. Inkjet inks comprising the branched polyurethane polymer is found to have excellent water redispersibility upon drying while still maintain good water resistance performance of the printed image. The amount of the polyurethane polymer typically ranges from about 0.05% to about 20% by weight, based on the total weight of the ink. More typically, the amount ranges from about 1% to about 12% by weight, based on the total weight of the ink.

The branched polyurethane colloidal particle stabilized with carboxyl and sulfonic acid functional groups in both acid and neutralized ionic form is derived from isocyanate, isocyanate reactive compounds with carboxy and/or carboxylate (carboxy/carboxylate) substitutes, isocyanate reactive compounds with sulfonic acid and/or sulfonate (sulfonic acid/sulfonate) substitutes, and isocyanate reactive compounds without ionic or ionizable substitutes. To introduce branching points for polymer chain growth, isocyanate can be a mixture of diisocyanate and polyisocyanate with 3 or more isocyanate groups; isocyanate reactive compounds without ionic or ionizable substitutes can be a mixture of compound with 2 isocyanate reactive groups and compound with 3 or more isocyanate reactive groups. In one embodiment the polyurethane polymer is derived from a diisocyanate, a first polydiol with OH number from 28 to 800, a second polydiol with a tertiary amine neutralized carboxyl group, a third polydiol or a diamine with an alkaline neutralized sulfonic acid group, and at least one triol or one polyamine, or mixtures thereof.

Suitable diisocyanates are those that contain either aromatic, cycloaliphatic or aliphatic groups bound to the isocyanate groups. Mixtures of these compounds may also be used. Examples of suitable diisocyanates include 1,6-hexamethylene diisocyanate, cyclohexane-1,3- and -1,4-diisocyanate; 1-isocyanato-3-isocyanatomethyl-3,5,5-trimethylcyclohexane (isophorone diisocyanate); bis-(4-isocyanatocyclohexyl)-methane; 1,3- and 1,4-bis-(isocyanatomethyl)-cyclohexane; 1-isocyanato-2-isocyanatomethyl cyclopentane; 2,4′-diisocyanato-dicyclohexyl methane; bis-(4-isocyanato-3-methyl-cyclohexyl)-methane, alpha,alpha,alpha′,alpha′-tetramethyl-1,3- and/or -1,4-xylylene diisocyanate; 1-isocyanato-1-methyl-4 (3)-isocyanatomethyl cyclohexane; and 2,4- and/or 2,6-hexahydrotoluylene diisocyanate. Among these, from the standpoint of preventing yellowing, aliphatic diisocyanates, specifically isophorone diisocyanate and 1,6-hexamethylene diisocyanate are preferably used.

Additional isocyanates with 3 or more isocyanates, or polymeric isocyanate may be used to make branched polyurethane. Examples of triisocyanate include 1,6-hexamethylene diisocyanate trimer and isophorone diisocyanate trimer. To avoid gelling of the polymer during stage of production, mole of the isocyanate coming from polymeric isocyanate is typically less than 25% that of diisocyanate, preferable less than 20%.

Examples of the second polydiol and third polydiol or diamine for use in the present invention include isocyanate reactive compounds with ionic and/or ionizable substitutes make up the hydrophilic segments in the polyurethane polymer enabling stabilization of polyurethane particles in aqueous phase. These compounds in general contain one or two, more preferably two, isocyanate reactive groups, e.g., hydroxy or amino groups, as well as at least one ionic and/or ionizable group which could be carboxyl/carboxylate groups and/or sulfonic acid/sulfonate groups. In the present disclosure, both the second polydiol, an isocyanate reactive compounds with carboxy/carboxylate group, and the third polydiol or diamine, an isocyanate reactive compounds with sulfonic acid/sulfonate groups ionic, are used to make the polyurethane polymer. Mole % of ionic and ionizable groups in the polyurethane binder are measured by acid number (AN). The AN is represented by the milligrams of potassium hydroxide required for neutralizing 1 gram (g) of a polyurethane polymer, as known by those skilled in the art. In order to stabilize a polyurethane particle in water with improved ink redispersibility while still maintaining water resistance after drying, the total AN from both carboxy/carboxylate and sulfonic acid/sulfonate groups ranges from 8 to 65, more preferably from 10 to 55, most preferably from 15 to 50. The ratio of AN of carboxy/carboxylate to AN of sulfonic acid/sulfonate typical ranges from 6:1 to 1:1, more preferably from 5:1 to 2:1, most preferably from 4:1 to 2.5:1.

Examples of the second polydiols are the hydroxy-carboxylic acids corresponding to the formula (HO)xQ(COOH)y wherein Q represents a straight or branched, hydrocarbon radical containing 1 to 12 carbon atoms, x is 1 or 2 (preferably 2), and y is 1 to 3 (preferably 1 or 2). Especially preferred acids are those of the above-mentioned formula wherein x is 2 and y is 1. These dihydroxy alkanoic acids are described in U.S. Pat. No. 3,412,054, the disclosure of which is incorporated by reference herein for all purposes as if fully set forth. Especially preferred dihydroxy alkanoic acids are the α,α-dimethylol alkanoic acids represented by the structural formula:

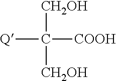

wherein Q′ is hydrogen or C1-C8 alkyl. The most preferred compound is α,α-dimethylol propionic acid, i.e., wherein Q′ is methyl in the above formula.

Suitable third polydiols and diamines containing sulfonic acid/sulfate group are hydroxy-sulfonic acids or amino-sulfonic acid/sulfonate with one or two isocyanate-reactive hydroxy or amino groups as well as at least one sulfonic acid/sulfonate group. Examples include, but not limited to, 2-(Bis(2-hydroxyethyl)amino) ethanesulfonic acid, sodium 2-[(2-aminoethyl)amino]ethanesulfonate, 2-(2-aminoethylamino) ethanesulfonic acid, 3-[(2-aminoethyl)amino]propanesulfonic acid, Polypropyleneglycol diamine-sulfopropylated, sodium salt, taurine, sodium 3-aminopropane-1-sulfonate, 6-amino-1-hexanesulfonic acid, and 2-(Methylamino) ethanesulfonic acid.

In order to stabilize polyurethane particles in aqueous phase, the neutralizing agent for carboxy and sulfonic acid groups to form carboxylate and sulfonate ionic groups are necessary. Examples of neutralizing agents for converting the acid groups to anionic salt groups include alkali metal cations (K⁺, Li⁺, Na⁺), trialkyl-substituted tertiary amines, such as triethyl amine, tripropyl amine, dimethylcyclohexyl amine, dimethylethyl amine, and 4-methylmorpholine-oxide, substituted amines such as diethyl ethanol amine, diethanol methyl amine. The conversion may take place after polymer synthesis or before the polymer synthesis at the monomer stage. The mole ratio of neutralizing agent to acid groups preferably ranges from 50% to 100%, more preferably at least 60%.

Suitable first polydiols are compounds with two hydroxy groups including low molecular weight monomers and polymeric diols having a molecular weight of about 100 to about 4000, or hydroxy number ranging from 28 to 800. Examples of low molecular weight diols include 1,3-propanediol, 1,3-cyclohexane dimethanol, 1,4-cyclohexane dimethanol, hydroquinone bis(2-hydroxyethyl) ether, and bisphenol-A. Examples of polymeric diols include polyester, polyether, polycarbonates, polyacetals, poly(meth)acrylates, polyamides, or mixed polymers such as a polyester-polycarbonate where both ester and carbonate linkages are found in the same polymer, similarly a polyether-polycarbonate where both ether and carbonate linkages are found in the same polymer. Typical polymeric diols have number average molecular weight ranging from about 250 to about 3000, preferably about 600 to about 2000. A combination of any of these diols can also be used.

A compound with trihydroxy (triol) or higher functional groups (polyols) generally known in polyurethane chemistry, such as trimethylolpropane and polyether triol, for example Arcol® polyether triols, is to be mixed with the first polydiol compound to achieve a branched polyurethane structure. To avoid gelling during the polyurethane production process, the hydroxy moles from triol and polyols must be lower than 30% of that of the diol compound, preferably lower than 25%, most preferably lower than 20%.

Suitable compounds with amino groups are typically diamine or polyamine chain extenders. Common examples include 1-amino-3-aminomethyl-3,5,5-trimethylcyclohexane, bis-(4-amino-cyclohexyl)-methane, bis-(4-amino-3-methylcyclohexyl)-methane, 1,6-diaminohexane, hydrazine, ethylene diamine, diethylene triamine, triethylene tetramine, tetraethylene pentaamine, pentaethylene hexamine or mixture thereof. Degree of polyurethane branching can be adjusted by amount of polyamine and ratio of polyamine to diamine if mixture is used.

A branched polyurethane refers to a polyurethane having non-linear chain structure with three or more polymer chain joined at one point. Suitable branched polyurethane particles stabilized by both carboxy/carboxylate and sulfonic acid/sulfonate groups are typically synthesized from isocyanate, isocyanate reactive compound with ionic/ionizable substitutes and isocyanate reactive compounds without ionic/ionizable substitutes as described above. The means to achieve branching of the polyurethane generally rely on at least one of the three compounds having three or more reactive sites. When only one or two reactive sites are available on each reactive compound, only linear polyurethane are produced. Example of branching techniques include, but are not limited to, the following:
(a) the isocyanate has at least three isocyanate groups such as polyisocyanates trimer including, for example, 1,6-hexamethylene diisocyanate trimer and isophorone diisocyanate trimer;
(b) the isocyanate-reactive compound has at least three reactive groups, such as triol or polyamine. Example of triols include such as trimethylolpropane and polyether triol, for example Arcol® polyether triols. Example of polyamines include such as diethylene triamine, triethylene tetramine, tetraethylene pentaamine, pentaethylene hexamine; and
(c) any combination of the above methods (a) and (b).

The degree of branching of the polyurethane to achieve the desired properties, especially balanced performance between ink redispersibility and water resistance can vary over a broad range. To avoid gelling or too much branching in the process of polyurethane production, mole of the isocyanate from polymeric isocyanate is typically less than 25% that of diisocyanate, preferable less than 20%. And the hydroxy moles from triol and polyols must be lower than 30% of that of the diol compound, preferably lower than 25%, most preferably lower than 20%.

Based on techniques described herein, a person having ordinary skill in the art is able to determine, via routine experimentation, the degree of branching needed for a particular type of polyurethane to obtain an effective ink-jet ink

### Ink Vehicle

The pigmented ink of this disclosure comprises an ink vehicle typically an aqueous ink vehicle, also known as an aqueous carrier medium.

The ink vehicle is the liquid carrier (or medium) for the aqueous dispersion(s) and optional additives. The term “aqueous ink vehicle” refers to an ink vehicle comprised of water or a mixture of water and one or more organic, water-soluble vehicle components commonly referred to as co-solvents or humectants. Selection of a suitable mixture depends on requirements of the specific application, such as desired surface tension and viscosity, stability with selected pigment dispersion and ink binder, drying time of the ink jet ink, and the type of media onto which the ink will be printed.

Examples of water-soluble organic solvents and humectants include: alcohols, ketones, keto-alcohols, ethers and others, such as thiodiglycol, Sulfolane, 2-pyrrolidone, 1,3-dimethyl-2-imidazolidinone and caprolactam; glycols such as ethylene glycol, diethylene glycol, triethylene glycol, tetraethylene glycol, propylene glycol, dipropylene glycol, tripropylene glycol, trimethylene glycol, butylene glycol and hexylene glycol; addition polymers of oxyethylene or oxypropylene such as polyethylene glycol, polypropylene glycol and the like; triols such as glycerol and 1,2,6-hexanetriol; lower alkyl ethers of polyhydric alcohols, such as ethylene glycol monomethyl ether, ethylene glycol monoethyl ether, diethylene glycol monomethyl, diethylene glycol monoethyl ether; lower dialkyl ethers of polyhydric alcohols, such as diethylene glycol dimethyl or diethyl ether; urea and substituted ureas.

In the present disclosure the ink vehicle was made to be rapid drying by including solvents with boiling points not higher than 230° C. at ambient atmospheric pressure. One of ordinary skill in the art can select suitable based on the disclosure herein. Such solvents generally include, but not limited to, alkanediols and glycol ethers types. Typical alkanediol solvents with boiling points not higher than 230° C. include, but not limited to, methyl pentane diol, ethylene glycol, 1,2-hexanediol, 1,2-propanediol, 1,3-propanediol, 1,2-butanediol, and 3-methoxy-3-methyl-1-butanol. Typical glycol ether solvents with boiling points not higher than 230° C. include, but not limited to, propylene glycol methyl ether, dipropylene glycol di-methyl ether, propylene glycol n-propyl ether, propylene glycol n-butyl ether, dipropylene glycol methyl ether, dipropylene glycol n-propyl ether, dipropylene glycol n-butyl ether, tripropylene glycol n-propyl ether, tripropylene glycol n-butyl ether, propylene glycol methyl ether acetate and dipropylene glycol methyl ether acetate.

The amount of glycol ether(s) and alkanediol(s) added is typically in the range of from 1% to 30%, and more typically from 2% to 20% by weight, based on the total weight of the ink.

The sum of all solvents excluding water, surfactants, biocides and buffers is typically less than 45% by weight based on the total weight of the ink, more typically less than 35% by weight based on the total weight of the ink, and most typically less than 30% by weight based on the total weight of the ink.

### Surfactants

Surfactants are commonly added to inks to adjust surface tension and wetting properties. Suitable surfactants include ethoxylated acetylene diols (e.g. Surfynol® series commercially available from Evonik), ethoxylated alkyl primary alcohols (e.g. Neodol® series commercially available from Shell) and secondary alcohols (e.g. Tergitol® series commercially available from Dow Chemical), sulfosuccinates (e.g. Aerosol® series commercially available from Cytec), organosilicones (e.g. DYNOL™, TEGO® Wet series commercially available from Evonik) and fluoro surfactants (e.g. CAPSTONE™ series commercially available from Chemours). Surfactants are typically used in amounts up to about 3% and more typically in amounts up to 2% by weight, based on the total weight of the ink.

Other ingredients, additives, may be formulated into the inkjet ink, to the extent that such other ingredients do not interfere with the stability and jettability of the inkjet ink. This may be readily determined by routine experimentation by one skilled in the art. Inclusion of sequestering (or chelating) agents such as ethylenediaminetetraacetic acid, iminodiacetic acid, ethylenediamine-di(o-hydroxyphenylacetic acid), nitrilotriacetic acid, dihydroxyethylglycine, trans-1,2-cyclohexanediaminetetraacetic acid, diethylenetriamine-N,N,N′,N″,N″-pentaacetic acid, and glycoletherdiamine-N,N,N′,N′-tetraacetic acid, and salts thereof, may be advantageous, for example, to eliminate deleterious effects of heavy metal impurities. Biocides may be used to inhibit growth of microorganisms.

### Ink Properties

Jet velocity, separation length of the droplets, drop size and stream stability are greatly affected by the surface tension and the viscosity of the ink. Pigmented ink jet inks typically have a surface tension in the range of about 20 dyne/cm to about 45 dyne/cm at 25° C. Viscosity can be as high as 30 cP at 25° C., but is typically much lower, more typically less than 10 cP at 25° C. The ink has physical properties compatible with a wide range of ejecting conditions, i.e., driving frequency of the piezo element or ejection conditions for a thermal head for either a drop-on-demand device or a continuous device, and the shape and size of the nozzle. The inks should have excellent storage stability for long periods so as not to clog to a significant extent in an ink jet apparatus. Furthermore, the ink should not corrode parts of the ink jet printing device and it should be essentially odorless and non-toxic. Preferred pH for the ink is in the range of from about 6.5 to about 8.5.

### Substrate

The inks of the present disclosure can print on any substrate without any limit. The inks of the present disclosure are most advantageous for printing on low absorption and non-absorption media. Low absorption media typically include coated paper, coated corrugated paper board, coated carton, and folding carton having low surface porosity due to calendaring and/or application of one or more layers of hydrophobic coating layers. Non-absorption substrates typically refer to plastic substrate such as acrylic resin, polyvinyl chloride, polycarbonate, polyethylene terephthalate, and polyolefin panel or films with various thickness and flexibility. All substrate may be subject to general surface treatment such as primer treatment or corona treatment prior to printing in order to improve ink fixing and adhesion performances.

### Printing

The present method relates to digitally printing substrate with low or no ink absorption. Typically, this involves the following steps:
(1) providing an inkjet printer that is responsive to digital data signals;
(2) loading the printer with the substrate to be printed;
(3) loading the printer with the above-mentioned inks or inkjet ink sets in any sequence in response to the digital data signals; and
(4) printing onto the substrate using the white inkjet ink followed by the inkjet ink or inkjet ink set in response to the digital data signals.

The white ink can be printed first as background image followed by color ink(s) or the color ink(s) can be first printed and then be covered by the white ink for reverse printing. Drying between the color ink(s) or between the white and color inks are optional.

Printing can be accomplished by any inkjet printer equipped for handling and printing low absorption and non-absorption substrates. A substrate printed with pigmented inks is dried at an elevated temperature after printing. The range of drying temperature varies with printer and dryer design and line speed, and is not too high to cause damage to the substrate. Generally, the drying temperature is not higher than 120° C., preferably not higher than 100° C., more preferably, not higher than 95° C.

### EXAMPLES

The invention is further illustrated by, but not limited to, the following examples, in which parts and percentages are by weight unless otherwise noted.

### Ingredients and Abbreviations

DMPA=dimethylol propionic acid
EDA=ethylene diamine
IPDI=isophoronediisocyanate
TEA=triethylamine
DETA=diethylenetriamine
MEK=methyl ethyl ketone
TMP=Trimethylolpropane
DMEA=dimethyl ethanolamine
CHDM=1,4-cyclohexanedimethanol
DBTL=dibutyltin dilaurate

Unless otherwise noted, the above chemicals were obtained from Aldrich (Mil-waukee, WI) or other similar suppliers of laboratory chemicals.

Terathane® T650—polyether polyol from Invista (Wilmington, DE)
Vestamin® A95—50% sodium 2-[(2-aminoethyl)amino]ethanesulfonate water solution from Evonik (Essen, Germany)
Eternacoll® UC-100 and UT-200—polycarbonate polyol from UBE industries (Tokyo, Japan)
Surfynol®440 and 420—nonionic surfactant from Evonik (Essen, Germany)
TEGO® Wet 280—silicone surfactant from Evonik (Essen, Germany)

### Cyan Pigment Dispersion

A cyan dispersion was prepared according to procedure disclosed in U.S. Patent Application Publication No. 2012/0214939, the disclosure of which is incorporated by reference herewith for all purposes as if fully set forth. A cyan TRB2 pigment was employed, and the dispersant was crosslinked after dispersing the pigment.

### Ink Polyurethane Binder

Comp. PU-1

To a dry, alkali- and acid-free flask, equipped with an addition funnel, a condenser, stirrer and a nitrogen gas line was added 15.8 g CHDM, 104.7 g Terathane T650, 4.0 g TMP, and 118 g acetone. The contents were heated to 40° C. and mixed well. 120 g IPDI was then added to the flask via the addition funnel at 40° C. over 5 min, with any residual IPDI being rinsed from the addition funnel into the flask with 2 g acetone.

The flask temperature was raised to 50° C., held for 240 minutes then followed by 15.8 g DMPA, then followed by 11 g TEA, was added to the flask via the addition funnel, which was then rinsed with 2 g acetone. The flask temperature was then raised again to 50° C. and held at 50° C. until NCO % was 2.0% or less.

With the temperature at 50° C., 570 g deionized (DI) water was added over 10 minutes, followed by 38 g EDA aqueous solution (as a 10% solution in water) over 5 minutes, via the addition funnel. The mixture was held at 50° C. for 1 hr, then cooled to room temperature.

Acetone (˜122.0 g) was removed under vacuum, leaving a final dispersion of polyurethane with about 30.0% solids by weight.

Comp. PU-2

To a dry, alkali- and acid-free flask, equipped with an addition funnel, a condenser, stirrer and a nitrogen gas line was added 824 g Eternacoll UC-100 and 835 g acetone. The contents were heated to 40° C. and mixed well. 443 g IPDI was then added to the flask via the addition funnel at 40° C. over 5 min, with any residual IPDI being rinsed from the addition funnel into the flask with 10 g acetone, followed by 0.22 g DBTL.

The flask temperature was raised to 50° C., held for 120 minutes then followed by 104 g DMPA, then followed by 70 g TEA, was added to the flask via the addition funnel, which was then rinsed with 10 g acetone. The flask temperature was then raised again to 50° C. and held at 50° C. until NCO % was 1.5% or less.

With the temperature at 50° C., 2750 g deionized (DI) water was added over 10 minutes, followed by 35.5 g EDA aqueous solution (as a 6.25% solution in water) over 5 minutes, via the addition funnel. The mixture was held at 50° C. for 1 hr, then cooled to room temperature.

Acetone (−855.0 g) was removed under vacuum, leaving a final dispersion of polyurethane with about 30.0% solids by weight.

Comp. PU-3

To a dry, alkali- and acid-free flask, equipped with an addition funnel, a condenser, stirrer and a nitrogen gas line was added 824 g Eternacoll UC-100 and 835 g acetone. The contents were heated to 40° C. and mixed well. 443 g IPDI was then added to the flask via the addition funnel at 40° C. over 5 min, with any residual IPDI being rinsed from the addition funnel into the flask with 10 g acetone, followed by 0.22 g DBTL.

The flask temperature was raised to 50° C., held for 120 minutes then followed by 104 g DMPA, then followed by 70 g TEA, was added to the flask via the addition funnel, which was then rinsed with 10 g acetone. The flask temperature was then raised again to 50° C. and held at 50° C. until NCO % was 1.5% or less.

With the temperature at 50° C., 2750 g deionized (DI) water was added over 10 minutes, followed by 35.5 g EDA aqueous solution (as a 6.25% solution in water) over 5 minutes, via the addition funnel. The mixture was held at 50° C. for 1 hr, then cooled to room temperature.

Acetone (˜855.0 g) was removed under vacuum, leaving a final dispersion of polyurethane with about 30.0% solids by weight.

### Inventive PU-1

To a dry, alkali- and acid-free flask, equipped with an addition funnel, a condenser, stirrer and a nitrogen gas line was added 31 g CHDM, 204 g Terathane T650, 8 g TMP, 10.5 g TEA and 225 g acetone. The contents were heated to 40° C. and mixed well. 234 g IPDI was then added to the flask via the addition funnel at 40° C. over 5 min, with any residual IPDI being rinsed from the addition funnel into the flask with 10 g acetone.

The flask temperature was raised to 50° C., held for 300 minutes then followed by 31 g DMPA, then followed by 10.5 g TEA, was added to the flask via the addition funnel, which was then rinsed with 10 g acetone. The flask temperature was then raised again to 50° C. and held at 50° C. until NCO % was 2.2% or less.

In a separate vessel Taurine aqueous solution was prepared by dissolving 25.5 g Taurine with 25.4 g 45 wt % KOH solution and 51 g deionized (DI) water.

With the temperature at 50° C., 1084 g deionized (DI) water was added over 10 minutes, followed by above prepared 102 g Taurine aqueous solution over 5 minutes via the addition funnel. The mixture was held at 50° C. for 1 hr, then cooled to room temperature.

Acetone (˜245.0 g) was removed under vacuum, leaving a final dispersion of polyurethane with about 30.0% solids by weight.

### Inventive PU-2

To a dry, alkali- and acid-free flask, equipped with an addition funnel, a condenser, stirrer and a nitrogen gas line was added 31 g CHDM, 204 g Terathane T650, 8 g TMP, 10.5 g TEA and 225 g acetone. The contents were heated to 40° C. and mixed well. 234 g IPDI was then added to the flask via the addition funnel at 40° C. over 5 min, with any residual IPDI being rinsed from the addition funnel into the flask with 10 g acetone.

The flask temperature was raised to 50° C., held for 300 minutes then followed by 31 g DMPA, then followed by 10.5 g TEA, was added to the flask via the addition funnel, which was then rinsed with 10 g acetone. The flask temperature was then raised again to 50° C. and held at 50° C. until NCO % was 2.2% or less.

With the temperature at 50° C., 1084 g deionized (DI) water was added over 10 minutes, followed by above prepared 43 g Vestamin A95 solution over 5 minutes via the addition funnel. The mixture was held at 50° C. for 1 hr, then cooled to room temperature.

Acetone (˜245.0 g) was removed under vacuum, leaving a final dispersion of polyurethane with about 30.0% solids by weight.

### Inventive PU-3 (D201308-322)

To a dry, alkali- and acid-free flask, equipped with an addition funnel, a condenser, stirrer and a nitrogen gas line was added 280 g Eternacoll UC-100, 4 g TMP, 10 g TEA and 287 g acetone. The contents were heated to 40° C. and mixed well. 162 g IPDI was then added to the flask via the addition funnel at 40° C. over 5 min, with any residual IPDI being rinsed from the addition funnel into the flask with 10 g acetone.

The flask temperature was raised to 50° C., held for 120 minutes then followed by 35 g DMPA, then followed by 13.5 g TEA, was added to the flask via the addition funnel, which was then rinsed with 10 g acetone. The flask temperature was then raised again to 50° C. and held at 50° C. until NCO % was 1.4% or less.

With the temperature at 50° C., 28 g Vestamin A95 solution was added over 5 minutes via the additional funnel, followed by 950 g deionized (DI) water addition over 10 minutes, followed by 28 g DETA aqueous solution (as 10% solution in water) over 5 minutes via the addition funnel. The mixture was held at 50° C. for 1 hr, then cooled to room temperature.

Acetone (˜307.0 g) was removed under vacuum, leaving a final dispersion of polyurethane with about 35.0% solids by weight.

All other inventive PUD type polymers, from PU-4 to PU-9, were made using processes similar to the preparation of the inventive PU-3 with ingredients listed in Table 1 below.

TABLE 1

| Monomer (g) | PU-4 | PU-5 | PU-6 | PU-7 | PU-8 | PU-9 |
|---|---|---|---|---|---|---|
| IPDI | 158 | 155 | 115 | 130 | 130 | 125 |
| DMPA | 36.5 | 25 | 31 | 31 | 31 | 25 |
| Eternacoll | | | 288 | 288 | 288 | 335 |
| UT-200 | | | | | | |
| Eternacoll | 288 | 315 | | | | |
| UC-100 | | | | | | |
| TMP | 2.5 | 5 | 4 | 8 | 8 | 8 |
| TEA | 24.5 | 17 | 21 | 21 | 21 | 17 |
| Vestamin | 31.5 | 27 | 25 | 31 | 25 | 25 |
| A95 | | | | | | |
| DETA | | 27 | | | 25 | 25 |
| (10%) | | | | | | |

### Ink Formulation

Inks used in the examples were made according to standard procedures in the inkjet art. Ingredient amounts are in weight percent of the final ink. Polymer binders and colorants are quoted on a solids basis. As an example of ink preparation, the ink vehicle was prepared and added with stirring to the aqueous ink binder. After stirring until a homogeneous mixture was obtained, the solution was added to the pigment dispersion and mixed until homogeneous again. Three cyan ink formulas, A, B and C, with different combinations of solvents and surfactants were prepared. Final inks employing various comparative and inventive PUs were made from these three ink formulas. The compositions of all inks tested are outlined in Tables 2-6 below.

TABLE 2
Ink Solvents and Boiling Points

| | Ink solvent | | | | |
|---|---|---|---|---|---|
| | | | Dipropylene | Dipropylene | |
| | 1,2-Pro- | 1,3-Pro- | glycol di- | glycol n- | |
| | panediol | panediol | methyl ether | propyl ether | Glycerol |
| Boiling | 187 | 211 | 175 | 213 | 290 |
| Point | | | | | |
| (° C.) | | | | | |

TABLE 3
Ink Formulas with Different Solvents and Surfactants

| Ingredients | Ink Formula A | Ink Formula B | Ink Formula C |
|---|---|---|---|
| Cyan pigment | 3% | 3% | 2.3% |
| PU binder | 3% | 3% | 3.5% |
| 1,3-Propanediol | | 18% | 15% |
| 1,2-Propanediol | 10% | 15% | |
| Dipropylene glycol di- | | | 3.75% |
| methyl ether | | | |
| Dipropylene glycol n- | | | 2.5% |
| propyl ether | | | |
| Glycerol | 15% | | |
| Surfynol 420 | 0.1% | 0.1% | |
| Surfynol 440 | 0.5% | 0.5% | |
| TegoWet 280 | | | 1.0% |

| | |
|---|---|
| DI water | Balance to 100% |

TABLE 4
Final Inks with Different PU Binder and Ink Formulas A and B

| Ink Name | Comp Ink A-1 | Comp. Ink A-2 | Ink B-1 | Ink B-2 |
|---|---|---|---|---|
| PU Binder | Comp. PU-1 | PU-3 | Comp. PU-1 | PU-3 |

TABLE 5
Final Inks with Different PU Binders and Ink Formula B

| | | | | | | | |
|---|---|---|---|---|---|---|---|
| Ink Name | Comp. | Comp. | Ink | Ink | Ink | Ink | Ink |
| | Ink B-1 | Ink B-2 | B-3 | B-4 | B-5 | B-6 | B-7 |
| PU Binder | Comp. | Comp. | PU-1 | PU-2 | PU-4 | PU-6 | PU-7 |
| | PU-1 | PU-2 | | | | | |

TABLE 6
Inks with Different PU Binders and Formula C

| Ink Name | Comp. Ink C-1 | Ink C-1 | Ink C-2 | Ink C-3 | Ink C-5 |
|---|---|---|---|---|---|
| PU Binder | Comp. PU-3 | PU-3 | PU-5 | PU-8 | PU-9 |

### Ink Redispersibility Testing

Ink redispersibility was evaluated by first depositing a drop of ink with a manual single-channel pipette on top of a Bytac VF-81 film lined with glass slides. Bytac VF-81 film, made by Saint-Gobair Performance Plastics from Poestenkill, NY, is a vinyl film supported FEP film with pressure sensitive adhesive in the back. A Bytac non-wetting film was chosen so that ink's drop size and surface area are consistent for all the tests. For this test, an ink's drop weight was kept at around 40 mg, and drop size was about 5 mm in diameter. After drying the ink drops at 50° C. for 20 min, the glass slides with dried ink was immediately immersed in 50 ml of DI water. After 30 min of soaking, the rating of the ink redispersibility was determined as the following:
1. Complete ink dissolution with no or few particles
2. Some particles or a few small solid chunks present
3. Significant number of pieces of solid chunks present
4. Dried ink as one piece of undissolved chunk

### Drying and Water Resistance Testing

A Mylar MLBT, a clear PET film from DuPont Teijing Film, was coated with Ink Formula A series and Ink Formula B series in Table 4 and Table 5 using a Gardco film applicator rod having a wire size of 5.0 (Paul N. Gardner Inc., Florida, USA) to form a coating having a dry thickness varying from 10 to 15 micron depending on solids and viscosity. All the above ink coatings were dried in a 65° C. convection oven for 3 minutes. Ink Formula C series in Table 6 were applied on a Styrex® polystyrene panel substrate using the same process except that the inks were subsequently dried in a 90° C. convection oven for 2 minutes instead.

The degree of drying of Ink Formula A series was evaluated by using a Q-tip to smudge the ink. If the ink was smudged away more than 50% without any resistance, the rating was poor. If the ink was smudges away about 30% or less, the rating was good.

The water resistance of Ink Formula B and Ink Formula C series was evaluated by using a water-soaked paper towel to smudge the ink with light pressure. The rating of water resistance was determined using the following criteria:
1. Ink was completely intact
2. Ink was still intact with slight color transfer
3. Ink was scratched with color transfer
4. Ink was scratched with significant color transfer and substrate is visible
5. Ink was completely removed

The ink redispersibility and degree of drying of Ink Formula A series and Ink Formula B series are summarized in Table 7 below. Although Comp. Ink A-1 and Comp. Ink A-2, containing glycerol as ink solvent, had excellent ink redispersibility better than Ink B-1 and Ink B-2, both inks had poor drying property. Even after storing at room temperature for 1 week, the inks were still not dried. Ink B-1 and Ink B-2, without glycerol, had good drying property immediately after oven drying.

TABLE 7

| Ink Name | Comp. Ink A-1 | Comp. Ink A-2 | Ink B-1 | Ink B-2 |
|---|---|---|---|---|
| PU Binder | Comp. PU-1 | PU-3 | Comp. PU-1 | PU-3 |
| Ink Redis- | 1 | 1 | 4 | 2 |
| persibility | | | | |
| Drying | Poor | Poor | Good | Good |

The ink redispersibility and water resistance of Ink Formula B series are summarized in Table 8 below. Comp. Ink B-1 and Comp. Ink B-2, containing Comp. PU-1 and Comp. PU-2 without any sulfonate functional groups, had poor ink redispersibility, while all inventive Inks B-3, B-4, B-5, B-6 and B-7 had improved ink redispersibility and good water resistance performances.

TABLE 8

| | | | | | | | |
|---|---|---|---|---|---|---|---|
| Ink Name | Comp. | Comp. | Ink | Ink | Ink | Ink | Ink |
| | Ink B-1 | Ink B-2 | B-3 | B-4 | B-5 | B-6 | B-7 |
| PU Binder | Comp. | Comp. | PU-1 | PU-2 | PU-4 | PU-6 | PU-7 |
| | PU-1 | PU-2 | | | | | |
| Ink | 4 | 3 | 1 | 3 | 1 | 1 | 1 |
| Redispersibility | | | | | | | |
| Water | 2 | 1 | 3 | 1 | 1 | 3 | 3 |
| Resistance | | | | | | | |

The redispersibility and water resistance of Ink Formula C series are summarized in Table 9 below. Comp. Ink C-1, containing Comp. PU-3 without branching as a binder, resulted in inferior water resistance although ink redispersibility is good.

TABLE 9

| | Ink Name | | | | |
|---|---|---|---|---|---|
| | Comp. | | | | |
| | Ink C-1 | Ink C-1 | Ink C-2 | Ink C-3 | Ink C-5 |
| PU Binder | Comp. | PU-3 | PU-5 | PU-8 | PU-9 |
| | PU-3 | | | | |
| Ink | 1 | 1 | 2 | 1 | 2 |
| Redispersibility | | | | | |
| Water | 5 | 1 | 4 | 5 | 5 |
| Resistance | | | | | |

1. An aqueous inkjet ink comprising an aqueous vehicle, a pigment, and a polyurethane binder; wherein the pigment is stabilized by a polymeric dispersant selected from the group consisting of polyurethane polymer, acrylic polymer, hydrolyzed styrene maleic anhydride copolymer, and mixtures thereof; the polyurethane binder comprising units derived from a diisocyanate, a first polydiol with OH number from 28 to 800, a second polydiol with a tertiary amine neutralized carboxyl group, a third polydiol or a diamine with an alkaline neutralized sulfonic acid group, and at least one triol and/or one polyamine, or mixtures thereof; and wherein the aqueous vehicle comprising one or more water soluble organic solvents with boiling points lower than 230° C. at ambient atmospheric pressure.

2. The aqueous inkjet ink of claim 1, wherein the polymeric dispersant is polyurethane polymer.

3. The aqueous inkjet ink of claim 2, wherein the polyurethane binder contains units derived from a diisocyanate, a first polydiol with OH number from 28 to 800, a second polydiol with a tertiary amine neutralized COOH group, a third polydiol with an alkaline neutralized sulfonic acid group, and at least one triol.

4. The aqueous inkjet ink of claim 3, wherein the polyurethane binder contains units derived from a diisocyanate, a first polydiol with OH number from 28 to 800, a second polydiol with a tertiary amine neutralized COOH group, a third polydiol with an alkaline neutralized sulfonic acid group, and at least one polyamine.

5. The aqueous inkjet ink of claim 2, wherein the polyurethane binder contains units derived from a diisocyanate, a first polydiol with OH number from 28 to 800, a second polydiol with a tertiary amine neutralized COOH group, a diamine with an alkaline neutralized sulfonic acid group, and at least one triol and one polyamine.

6. The aqueous inkjet ink of claim 1, wherein the polymeric dispersant is acrylic polymer.

7. The aqueous inkjet ink of claim 6, wherein the polyurethane binder contains units derived from a diisocyanate, a first polydiol with OH number from 28 to 800, a second polydiol with a tertiary amine neutralized COOH group, a third polydiol with an alkaline neutralized sulfonic acid group, and at least one triol.

8. The aqueous inkjet ink of claim 6, wherein the polyurethane binder contains units derived from a diisocyanate, a first polydiol with OH number from 28 to 800, a second polydiol with a tertiary amine neutralized COOH group, a third polydiol with an alkaline neutralized sulfonic acid group, and at least one polyamine.

9. The aqueous inkjet ink of claim 6, wherein the polyurethane binder contains units derived from a diisocyanate, a first polydiol with OH number from 28 to 800, a second polydiol with a tertiary amine neutralized COOH group, a diamine with an alkaline neutralized sulfonic acid group, and at least one triol and one polyamine.

10. The aqueous inkjet ink of claim 1, wherein the polymeric dispersant is styrene maleic anhydride.

11. The aqueous inkjet ink of claim 10, wherein the polyurethane binder contains units derived from a diisocyanate, a first polydiol with OH number from 28 to 800, a second polydiol with a tertiary amine neutralized COOH group, a third polydiol with an alkaline neutralized sulfonic acid group, and at least one triol.

12. The aqueous inkjet ink of claim 10, wherein the polyurethane binder contains units derived from a diisocyanate, a first polydiol with OH number from 28 to 800, a second polydiol with a tertiary amine neutralized COOH group, a third polydiol with an alkaline neutralized sulfonic acid group, and at least one polyamine.

13. The aqueous inkjet ink of claim 10, wherein the polyurethane binder contains units derived from a diisocyanate, a first polydiol with OH number from 28 to 800, a second polydiol with a tertiary amine neutralized COOH group, a diamine with an alkaline neutralized sulfonic acid group, and at least one triol and one polyamine.
